(19) United States
(12) Patent Application Publication
(10) Pub. No.: US 2005/0028206 A1
(43) Pub. Date: Feb. 3, 2005

(54) Digital interactive delivery system for TV/multimedia/internet

(75) Inventors: Allan B. Cameron, Saint John (CA); Ian K. Jones, Rothesay (CA); Darren B. Swansburg, Quispamsis (CA); David J. Alston, Welsford (CA); Jeff L. Furlong, New Brunswick (CA); Sean G. Higgins, Saint John (CA)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(73) Assignee: IMAGICTV, INC.

(21) Appl. No.: 10/924,213

(22) Filed: Aug. 23, 2004

Related U.S. Application Data
(63) Continuation of application No. 09/675,849, filed on Sep. 28, 2000.
(63) Continuation-in-part of application No. PCT/CA99/00505, filed on Jun. 3, 1999.
(60) Provisional application No. 60/088,135, filed on Jun. 4, 1998.

(51) Int. Cl. H04N 5/445; H04N 7/18; H04N 7/173; G06F 13/00; G06F 3/00

(52) U.S. Cl. 725/46; 725/45; 725/110; 725/112; 725/113; 725/51

(57) ABSTRACT

A computer software application for end-to-end management of the delivery of IP-configured integrated multimedia signals (e.g., TV, video, Website, etc.), on an interactive basis, to a subscriber device (being a personal computer (PC) and monitor coupled thereto or television/set-top box combination). The system manager comprises an interactive program guide (IPG) component configured for providing to the subscriber an interactive program guide (IPG) permitting selection of the multimedia signals by the subscriber and a subscriber device component associated with the subscriber device and configured for receiving instructions from the subscriber. The subscriber device includes a decoder configured for converting the selected IP multicast format signals into a format for display on PC monitor or television. A PC component is configured for displaying the converted multimedia signals on the PC monitor in the form of a player window and for displaying a remote controller GUI on the monitor, the remote controller GUI being a model of a hand-held remote controller and controllable by the subscriber for controlling the selection of signals from the IPG. The interactive program guide provides drop down box selection and scroll bar GUI features.

### CROSS-REFERENCE TO RELATED APPLICATIONS

This application is a continuation of U.S. patent application Ser. No. 09/675,849, filed on Sep. 28, 2000, which claims priority to U.S. Provisional Application No. 60/088,135, filed Jun. 4, 1998 and which is a continuation-in-part of International Application No. PCT/CA99/00505, filed Jun. 3, 1999, which applications are incorporated herein by specific reference.

### TECHNICAL FIELD

The invention generally provides a computer software application for end-to-end management of the delivery of IP-configured integrated multimedia signals (e.g., TV, video, Website, etc.) to a subscriber (consumer) using multicast transmissions over a broadband network and, in particular, provides a system and method for use by a service provider (e.g., a telco) for interactive delivery of multimedia directly to a subscriber's personal computer (PC) or television/set-top box combination.

### BACKGROUND

TV broadcasts are currently delivered through service providers such as cable companies, and satellite operators and, of course, direct broadcast reception via traditional antennas and rabbit ears. Conventional cable service requires the installation of a dedicated cable to the subscriber's residence. Satellite broadcast service requires that the user have a satellite dish located on or somewhere close to their residence. Antennas and rabbit ears are generally limited to the reception of local programming.

It is well known that the purchase of personal computers by homeowners has increased dramatically in recent years. Typically, these computers are used for word processing, accounting and other record keeping purposes. Most of these computers also have modems for connection to the Internet through an Internet Service Provider (ISP) utilizing conventional telephone service. Frequently, however, these modems have a low baud rate that makes downloading of information, particularly graphics, unacceptable.

To date, the provision of multimedia/television services has relied on the use of set-top boxes or PC's with added hardware devices such as TV tuner cards to convert signals from cable, satellite and DSL television systems which are configured for display on a television. Often TV viewers in a home may wish to watch programming in different rooms. The cost of additional set-tops and or television devices in a home can be prohibitive. Adding hardware to a PC to seek set-top like functionality is both costly and difficult for the average consumer to perform.

There is, therefore, a need in the marketplace for means to allow service providers to offer an alternative to cable and satellite TV as presently known.

Further, there is a need for a system that overcomes the foregoing problems so as to enable usage of an ordinary PC and monitor to receive and display broadcast multimedia/television signals. Note that such PC's already exist in many consumer's homes and are often underutilized as compared to the televisions in those homes. Additionally, there is a need by broadcast providers to expand the types of receiver devices available in the marketplace so that multimedia/television broadcasts may be targeted outside of the traditional home location and instead to active PC users who may be located anywhere (or may even be roaming) and thereby greatly broaden access to broadcast content.

### SUMMARY OF THE INVENTION

The present invention enables the provision of subscription multimedia/television/Internet services over managed broadband networks and provides an interactive client (subscriber) device component, such as in the form of a PC-based software component interface, that enables a PC to receive, select and process multimedia/television/internet signals for display on the PC monitor.

In accordance with the invention there is provided a management system and method for managing the delivery of multimedia broadcast signals from a broadcast provider to a subscriber and providing to the subscriber interactive access to the signals, the broadcast signals being configured according to IP (Internet Protocol) format for multicast transmission over a broadband network and reception by a subscriber device. An interactive program guide (IPG) component is configured for providing to the subscriber an interactive program guide (IPG) permitting selection of the multimedia signals by the subscriber. A subscriber device component associated with the subscriber device is configured for receiving instructions from the subscriber. The subscriber device may comprise a set top box and a television coupled thereto, the set top box comprising a decoder configured for converting the selected IP multicast format signals into a display format for display on the television, or a computer and a computer monitor coupled thereto, the computer comprising a decoder configured for converting said IP multicast format signals into a display format for display on the monitor. The subscriber device comprises a subscriber input interface (e.g., keyboard/mouse) coupled thereto for receiving instructions from the subscriber.

The subscriber device component associated with the subscriber's computer includes a PC component configured for displaying the converted multimedia signals on the monitor in the form of a player window. The PC component is preferably configured for displaying a remote controller GUI on the monitor, with the remote controller GUI being controllable by the subscriber through the subscriber input interface for controlling the selection of the multimedia signals from the IPG. Preferably, the remote controller GUI is a model of a hand-held remote controller.

Preferably, the interactive program guide provides a drop down box selection and scroll bar GUI features and program schedule cells associated with a channel lineup listing selectable television broadcast channels. The channel lineup may include one or more channels corresponding to selectable URLs.

Significantly, all of these features are delivered via IP and ATM technologies using a single point of access rather than a combination of delivery systems such as satellite and cable.

### BRIEF DESCRIPTION OF THE DRAWINGS

The present invention will now be described in greater detail with reference to the following drawings in which like reference numerals refer to like elements throughout.

FIG. 1 is a block diagram of a preferred multimedia broadcast delivery system in accordance with the invention (hereinafter referred to as the “delivery system”);

FIG. 2 is a further block diagram of the delivery system;

FIG. 3 is a schematic block diagram of the elements of the delivery system and the operational components of the system manager component 40 (hereinafter referred to as the “system manager”);

FIG. 4 is a schematic operational diagram of the delivery system and system manager;

FIG. 5 is a schematic diagram illustrating a layered relationship of the components of the delivery system and system manager;

FIG. 6 is an exemplary interactive program guide (IPG) generated by the system manager for display by a television through a set-top box;

FIG. 7 is another exemplary interactive program guide (IPG) generated by the system manager for display by a personal computer (PC);

FIG. 8 is an exemplary player window and virtual remote control generated by the system manager for display by a personal computer (PC);

FIG. 9 is an exemplary virtual remote controller, showing the basic functions available, as generated by the system manager for display by a personal computer (PC);

FIG. 10 is the virtual remote controller of FIG. 10 but showing the “options” box selected and the various available optional functions displayed; and,

FIG. 11 illustrates a system for concurrent transmission of MPEG-1 and MPEG-2 encoded signals.

### DETAILED DESCRIPTION OF A PREFERRED EMBODIMENT

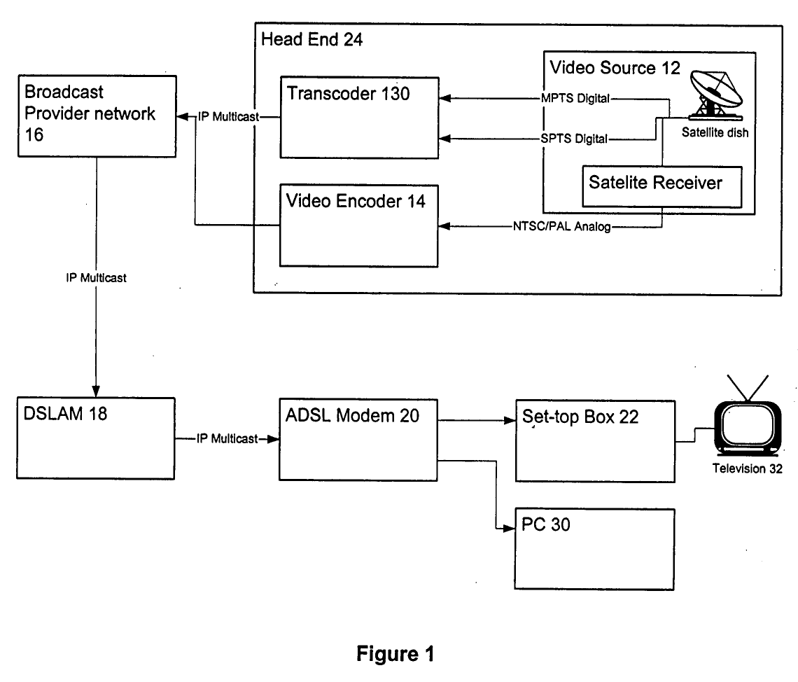

FIG. 1 is a high-level block diagram of the basic elements of an exemplary multimedia delivery system as contemplated herein; for the convenience of the reader a glossary of several terms used herein, setting out their well-known meaning in the communications art, is provided herein as Appendix A.

At the head-end 24 of the system a video source 12 retrieves multimedial television/Internet signals for broadcast from various sources such as satellites in the form of MPEG-compliant, Multi-Program Transport Streams (MPTS) and these signals are delivered to (analog-to-digital) video encoders 14 or (digital-to-digital) transcoders 130 where they are converted to one or more IP Multicast Single-Program Transport Streams (SPTS). The encoder 14 encodes analog video and audio inputs. The transcoder 130 decodes digital video and audio signals, perhaps high-speed MPEG video SPTS or MPTS, and re-encodes them into a format which is suitable for the subscriber device being STB 22 or PC 30. Each IP multicast SPTS is a packetized MPEG stream which is subsequently sent out over a broadcast provider network 16 to a Digital Subscriber Line Access Multiplexer (DSLAM 18) 18 which might be located in a telephone company central office. The DSLAM 18 serves two purposes: firstly, it connects broadband lines in the transport network to xDSL lines in the access network and, secondly, it separates high-speed data from voice data, putting high speed data on the data network and low speed data on the conventional phone system. This allows concurrent use of the telephone and the system manager components on the same phone line. An IP Multicast signal from the DSLAM 18 is delivered to a subscriber's residence over an xDSL link such as an Asymmetric Digital Subscriber Line (ADSL), where it is received by an ADSL modem 20 and delivered to a client server such as a set top box (STB) 22 or a PC 30. More precisely, xDSL lines connect the DSLAM 18 to an ethernet interface on the xDSL modem, and a 10BaseT cable connects the ethernet interface on the xDSL modem to an ethernet interface card on the set-top or PC.

The delivery system comprises software for enabling a service provider to offer broadcast television over Internet Protocol (IP), including IP multicast and unicast, which allows channel browsing by selecting and retrieving IP multicast streams. IP multicast is characterized by the sending out of data to distributed servers on a multicast backbone network. For large amounts of data (including video transmissions), IP multicast is more efficient than normal Internet unicast transmissions because the server can broadcast a message to many recipients simultaneously. Unlike traditional Internet traffic that requires separate connections for each source-destination pair, IP multicasting allows many recipients to share the same source. This means that just one set of packets is required to be transmitted for all the destinations.

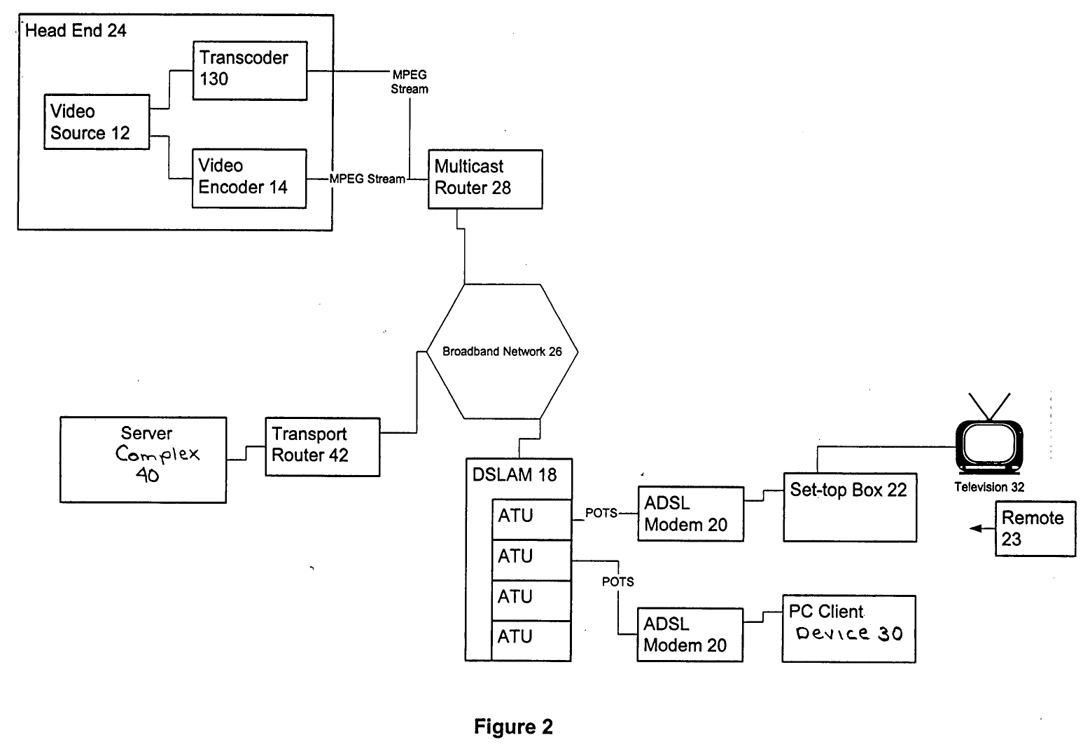

If the bit rate of the satellite transmission is not greater than 1 MBPS the signal may be transcoded directly to IP multicast MPEG. This takes existing digital transmissions from a satellite and reprocesses them for delivery on an IP Multicast delivery system. The advantages of this are that it lowers the cost of head-end equipment 24 (satellite dish, etc.) by replacing the encoder 14 with a transcoder 130, and it also maximizes the quality of the signal being delivered from a digital signal source at the head-end (since it is only digitized once, and remains that way). At the broadcast provider location a split/distributed head-end (signal from satellite) can also be employed to optimize transport facility cost. As shown in FIG. 2, the video source may be a satellite located at head-end 24, which may be operated by a broadcast provider such as a telephone company or other service provider. The head end 24, and a system server complex 40, interface with a broadband network 26 through an IP multicast router 28 and a transport router 42, respectively.

Digital video equipment gathers, processes, and distributes video. This equipment can include satellite dishes, satellite receiver units, encoders, remultiplexers, video servers, and IP gateways. Encoders and remultiplexers process live video, and video servers support the distribution of stored video. Encoders and remultiplexers perform two main functions: firstly, they convert individual MPEG-compliant, Multi-Program Transport Streams (MPTS) from satellite into one or more IP multicast Single Program Transport Streams (SPTS) in real time and, secondly, they multicast the IP SPTS's over the service provider's IP network.

The server complex of the management system 40 (also referred to herein as the “system manager”, “DTVM” or “Digital TV Manager”) contains vital software components and comprises two main servers, namely, a system manager (DTVM) server and a database server. The DTVM server incorporates standard web server software, and other standard software, such as JVM (Java Virtual Machine), DHCP/BootP, RPC, and NFS. The database server runs standard database software and stores all data for consumers (such as IPG data) including events data.

The broadband network is IP Multicast compatible and has sufficient bandwidth capacity to transport encoded video signals. A subscriber to the broadcast service has access to. the network via a broadband link. Examples of broadband links include Digital Subscriber Line (xDSL) (such as Asymmetric Digital Subscriber Line (ADSL)) Asynchronous Transfer Mode (ATM), Frame Relay, Synchronous Optical Network (SONET), Local Multipoint Distribution System (LMDS), Hybrid Fiber Coax (HFC), or Fiber To The Home (FTTH). xDSL is of particular significance because it allows a broadcast provider to deliver programming to residential communities over existing copper wire (i.e., the twisted pairs linking the customer premises to the telecommunications network) without having to delay introduction of the service until the other access technologies become widely available.

The subscriber can access the TV broadcast with either a personal computer (PC) 30 having an associated monitor or a television 32 with a set top box (STB) 22 such that, in essence, the STBs and PC's act as network computers. Each PC and STB is configured from downloaded multicasted data sources and uses a head-end server for persistent storage. Accordingly, the consumer access 20 operates out of memory (RAM) rather than a hard disk and this means that there is no dependence at the consumer end on moving parts and this, in turn, provides improved performance, decreased costs, reduced noise and fewer equipment failures and facilitates automatic software upgrades. Dependence on servers at the consumer-end is minimized and servers are not required for regular television viewing or Web browsing. Once an STP or PC boots up, basic television viewing depends only on the availability of the video source and the associated network.

The set top box 22 includes decoding circuitry for decoding MPEG-1 and/or MPEG-2 as well as IP Multicast. To view the broadcast from a PC 30 it is equipped with appropriate software and may optionally be equipped with an associated MPEG card. The STB 22 is activated by an interface unit such as a keyboard or remote device 23 and the PC 30 interfaces the subscriber via a keyboard and/or mouse.

As shown in FIGS. 1 and 2 the broadcast provider is able to access television broadcast signals from various sources such as satellite 12, off-air broadcast or a static source such as a storage medium containing movies or the like. The service provider encodes the broadcast signal (MPEG) and makes it available to service subscribers (i.e., consumer users of the delivery system) through the broadband network 26 using the Internet protocol (IP). The system manager 40 is linked to the network 26 via a transport router 42 and provides end-to-end management of services and resources provided by the integrated broadcast delivery system.

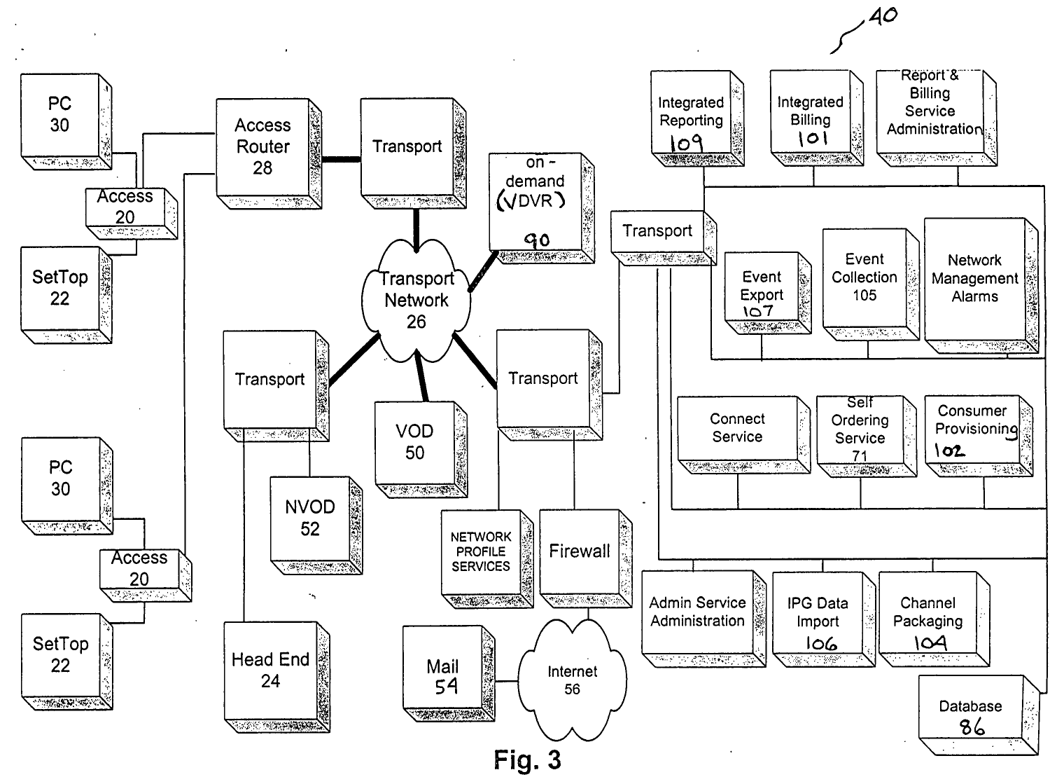

FIG. 3 shows the architectural configuration of the delivery system including the consumer end appliances (PC and/or STB), the broadband IP network and the DTVM components. FIG. 3 also shows another aspect of the deliverable services, i.e., Internet access 56. User access to the network is through an xDSL access element such as an ADSL Transmission Unit (ATU) 20. The broadband IP network and services section includes access router 28 and the transport network ‘cloud’ 26. The transport network 26 has access to various components running parallel to the head-end, namely, video-on-demand (VOD) 50 and near video-on-demand (NVOD) 52, and the following additional “on-demand” applications: virtual digital video recorder (VDVR) 90, “timeless” TV application and TV-on-demand, as well as e-mail 54 and Web access through the Internet 56.

For standard broadcast signals and pay-per-view (PPV) or near video on demand (NVOD) services a multicast IP protocol is used in order to make efficient use of bandwidth. With this protocol numerous subscribers can have access to a program at the same time. For true video-on-demand service (VOD, VDVR, timelessTV and TV-on-Demand), however, a unicast IP protocol is used. The DTVM software application 40 provides several features to a subscriber of the delivery and manager systems. These include but are not limited to customer profile management 68, billing and reporting 84, Interactive Program Guide (IPG) access 60, connection and channel packaging 104 including a self-service option 71, channel blocking (not shown), on-line multilingual support (not shown) and information banner functions 64.

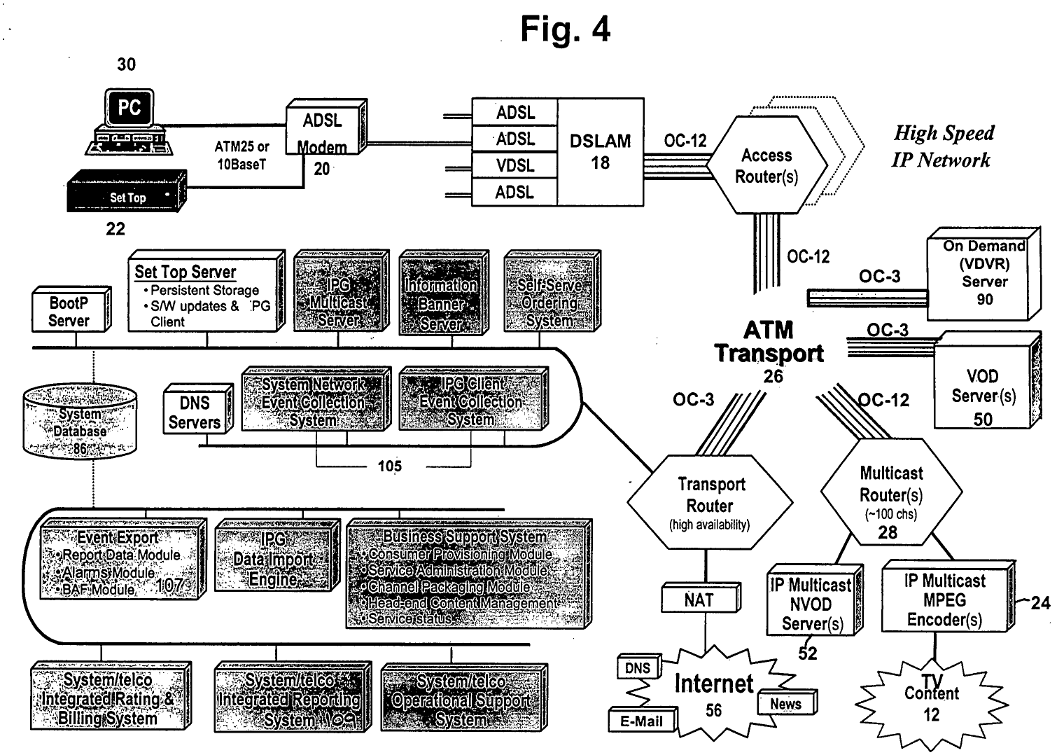

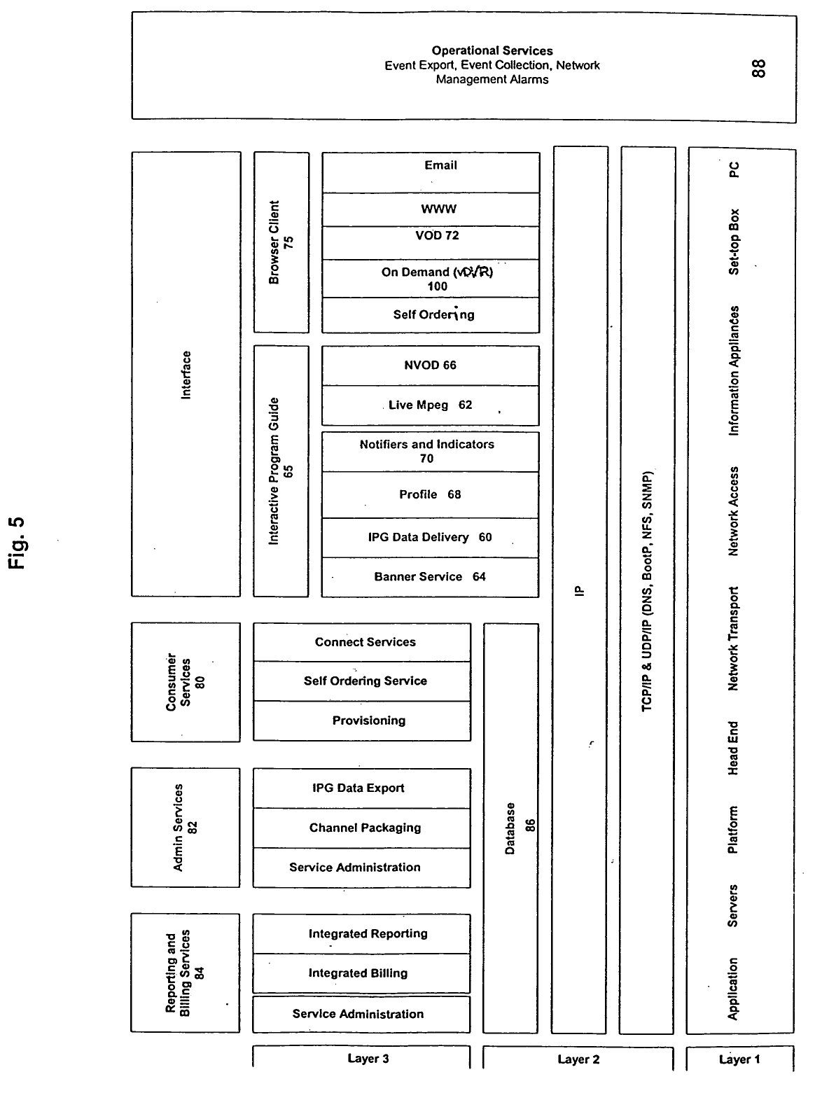

FIG. 4 is an operational schematic diagram of the broadcast delivery system. The Digital Subscriber Line Access Multiplexer (DSLAM 18) 18 at the edge of the high speed IP network is a network device which may be located at a telephone company central office. The DSLAM 18 enables a telephone company to provide subscribers with xDSL, such as ADSL, technology and to connect the subscriber to a fast backbone such as an ATM transport network 26. The ATM network routes the various broadcast services, previously mentioned, to the DSLAM 18 which, in turn, makes them accessible to subscribers via their PC 30 and/or STB 22. FIG. 5 shows in a layer format the relationship between suppliers of the various components of the overall TV broadcast delivery system. At the bottom layer (layer 1) are the equipment and appliance suppliers such as set top box and computer suppliers, etc. The second layer (layer 2) represents the service provider such as a Telco who make available the IP and other protocols necessary to transport the video and furnish the manager application functions between the service provider and subscriber. The third layer (layer 3) includes the application functionality of the DTVM. As indicated in FIG. 5, these include consumer 80 and administration 82 service components, reporting and billing components 84 and IPG 65 and browser 75 components.

The system manager (DTVM) utilizes some standards-based components and its components can be categorized into two groups, namely, client (subscriber) and server components. Client components run locally on the STB or PC and are collectively referred to herein as subscriber device components. They provide three capabilities: firstly, they provide viewing capability based on a user profile; secondly, they provide business rules based on a user profile that specify permissions and restrictions to resources; and, thirdly, they forward events and registration information to the server. Registration information includes, among other things, the IP address of each device. Server components generate, manage, and update the data that is sent to the STB or PC. Server components also organize data according to a user profile. The DTVM may run on a Sun Solaris platform (this currently being a preferred platform) but the platform used will be dictated by the service provider based on its needs.

The subscriber device component of this embodiment uses four components that are installed the STB or PC, namely, an MPEG player, a browser, a networking API and a windowing API. The MPEG player supports video viewing and the browser supports Web browsing. The networking API supports the protocols used by the DTVM applications such as IP, NFS, and MPEG. The windowing API specifies what interface screens can be drawn and how. Within the DTVM software there are many components which perform the following functions: management of the display of all content (including MPEG video, Interactive Program Guide (EPG), and web pages), processing of remote control commands, providing time measurement ability, sending of events data to the server, listening for updates from the server in the IP multicast stream, prompting the user for registration input, sending retrieved data to the server for further processing, and registering STB or PC with the DTVM/service provider. An SNMP Management Information Base (MIB) component is also provided in each STB or PC which, conventionally, uses SNMP to query and reset remote indicators (i.e., receives and responds to SNMP compliant messages) and, unconventionally, uses SNMP to update consumer specific data on client devices for purposes of remote diagnostics, notification of new data availability and reminders or news items.

Several “off the shelf” server components are used by the system manager and they play the following roles:
A Web server stores servlets that support administration (provisioning, remote diagnostics, etc.) and self service (pay-per-view, channel blocking, etc.) transactions and standard products such as the NETSCAPE™ Enterprise Server and APACHE™ are used in this.
JDBC (JAVA™ Database Connectivity) and SQL*NET™ are used to enable the Java applications of the DTVM to access the database.
A database stores all data for consumers, the IPG, events, etc., and the persistence architecture of the DTVM is able to support multiple database models, including ORACLE™ and SYQUEST™.
The operating system layer provides BootP/DHCP and NFS components to support set top box boot up and profile retrieval.

The DTVM server components are written in the JAVA™ programming language and their roles are as follows:
DTVM uses two daemons (i.e., automated background processing modules): multicast and Remote Procedure Call (‘RPC’). The multicast daemon broadcasts multicast data content to specific multicast addresses to deliver data to the STB or PC. The RPC daemon forwards events data and registration information from the STB or PC to the database server. The RPC daemon also has an RMI (Remote Method Invocation) interface to support distributed Java applications. Both daemons use the SUN™ native JVM (Java Virtual Machine).
Batch transactions automate the IPG update process. The IPG update process consists of three phases: in phase one a retrieval process uses FTP to retrieve a data file from the data provider that contains television programming data, in phase two a mapping process maps the data file to the database and in phase three a preparation process formats and forwards the IPG data to the multicast server.
Servlets may be used to generate HTML pages that support service administration and self service transactions and also to invoke persistence architecture components in order to make changes to the database. Alternatively, JSP (Java Servlet Pages) and applets may be used (instead of servlets) if increased configurability and interactivity of self-service screens is desired.
Persistence architecture components facilitate connections and exchanges between Java business objects and database tables.

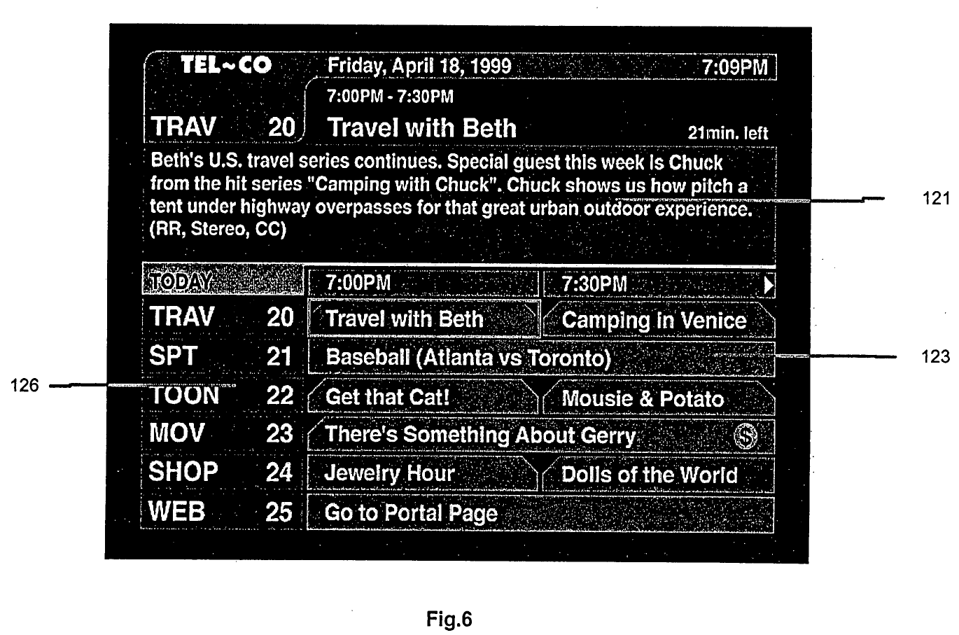

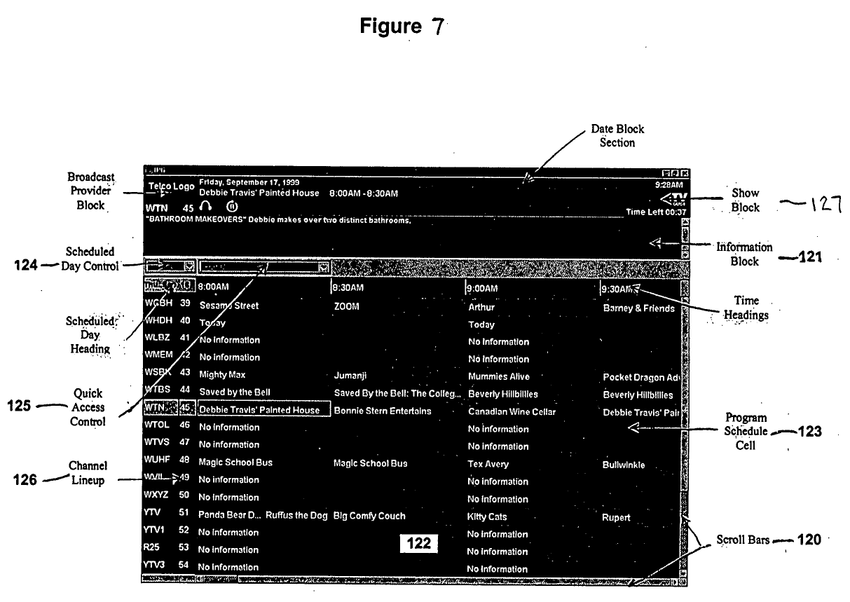

The subscriber accesses the IPG through components in the STB 22 or PC 30. Some memory may be available locally for storing specific information, or alternatively, the entire IPG may be maintained in the network. The subscriber uses the remote control or keyboard/mouse 23 for interfacing with the IPG displayed on the television or computer monitor the interactive nature of the IPG gives a subscriber control over many aspects of the broadcast system. Program scheduling information may be presented in a form as shown in FIGS. 6 and 7 (FIG. 6 showing a STB IPG and FIG. 7 showing a PC IPG). With this listing displayed on a TV monitor or computer display the user can scan the channel line-up 126 and program schedule cells 123 listed on the display, choose, highlight and then click on a desired program and the television or computer will then automatically retrieve the selected IP multicast stream. In addition, as indicated in FIGS. 6 and 7, another clicking configuration may display a brief information banner 121 with relevant data concerning program content and timing for a highlighted selection (i.e., “Travel with Beth” in FIG. 6 and “Debbie Travis' Painted House” in FIG. 7). Additionally, a user can click on a desired program and select it for recording (i.e., utilizing the VDVR application). The DTVM in conjunction with the IPG provides a subscriber with the ability to channel browse for TV programs and/or Web sites and order pay-per-view programs. In the preferred embodiment a seven day channel lineup with scheduled automatic refresh is provided. The IPG client software is automatically updated by the system at regular intervals. The data provider must provide programming data in a pipe delimited text file once every 24 hours, or such other period as may be appropriate. The DTVM system transfers data from the text file into the service provider's database and then multicasts IPG data from the service provider's database across the network to the user on the PC display or television.

In the PC environment, as shown by FIG. 7, the IPG information is displayed on the PC's monitor for programs that are currently in progress as well as future scheduled programs. Using a keyboard or mouse, the consumer is able to: use a seven-day schedule for available channels; by browsing the IPG window, change the day by selecting another day from the Scheduled Day controllerl24 which is operative as a drop down control; quickly access other times in the current day by a Quick Access controller 125; obtain the details, in the form of a Show Block 127 and an Information Block 121, for a show when it's clicked; retrieve the IP multicast stream corresponding to the selected channel when a Program Schedule cell 123 is double clicked (or the <Enter> key is pressed) if the show is currently running. The Scheduled Day controller 124 is a list box giving the consumer the possibility to select the day he/she is interested to browse. When the IPG window is activated, the current day is displayed. All future dates are shown as the day of the week followed by the calendar month and day of month. The Quick Access controller 125 is also a list box providing an easy and fast access to a specific daytime. A cell of the Channel Lineup 126 column contains the station call letters and channel number for the station that is broadcasting the listed programs. On operation of the IPG the top station of the channel lineup is the channel currently playing unless no station is playing in which case the top one is the first available.

The data associated with the Program Schedule Cells 123 is controlled according to the following. When the IPG window is activated, the 7 day IPG data is already prepared and stored in the local memory of the PC (the client device). The system selects the IPG data of the selected day beginning with the current time and displays it in the IPG window. When another day is selected by the Scheduled Day controller 124, the corresponding data is selected and displayed again. These cells contain the show title and represent the area the consumer may browse through to view the one day program schedule or select a program that is currently being broadcast on a station. When a highlighted program is currently in progress the consumer may select that program by double clicking (or by pressing the <Enter> key) the program cell 123. The cells 123 are displayed with comers marking the start and end times.

A program cell 123 can be selected through three different processes as follows: (1) The user can use the mouse to click a cell and the cell will then be the selected cell; (2) The user can scroll using the keyboard arrow keys and each arrow key press will select the cell the user is navigating to; or, (3) When the system timer adds a minute to the local clock and the first cell on the grid then becomes in the past, the new first cell in that row will become the selected cell. If the selected cell is not in view when automatic scrolling takes place, nothing will change, but the system will display the appropriate selected cell when it comes into view.

Similarly, three different processes are provided for changing the viewable contents of the program cells grid: (1) The user may use the arrow keys to navigate and as the selected cell meets a boundary, the grid automatically scrolls if there is more information in the desired direction; (2) The user may click the scroll bars 120 and as long as there is information in the direction the user is scrolling, the grid will scroll; or, (3) If the system clock updates and visible cells become in the past, the grid will automatically scroll.

The IPG functionality as described above is identical to that of the TV/set-top box environment but without the PC's windows-based features including the ability to minimize/resize the IPG window, the scroll bars 120 and the drop down list box functionality provided by the Scheduled Day controller 124 and Quick Access controller 125. In addition, the PC's user-input mouse clicks would be substituted with STB remote controller clicks.

When the IPG component is invoked (i.e., by clicking on the IPG icon 109 or on the Remote Controller's IPG button) the system manager retrieves the correct current date and time for the consumer's time zone, corrects all the shows times according to the consumer's time zone, selects the IPG data for the whole current day beginning with the current time, assigns the selected data to the IPG window's components and activates the IPG window.

As stated above the IPG is a software application that operates in, for example, both a windows and set-top environment and provides a link to a client MPEG-1/MPEG-2 decoder and a client conditional access module. This software also provides the user with access to all broadcast content on the broadband multicast IP network as well as supporting services (i.e., subscription management). The IPG data delivery software component 60 is server software which provides the broadcast content schedules to the EPG client component software 65 based on the broadcast provider, customer location and customer profile. The server software 60 operates to extract broadcast content schedules from various existing data sources.

A banner server 64 is server software which provides scheduled ad insertion into the IPG based on certain criteria such as the time of day, the broadcast provider, the customer location and the customer profile. A near video-on-demand (NVOD) server 66 provides scheduled managed delivery of pre-recorded material via an IP multicast network. A customer profile management system/subscription management software component 68 stores and tracks customer preferences, usage patterns, billing status, mailing addresses, client devices, service subscription, etc. It also provides the core data for many of the other components of the system manager (DTVM). A notifier and indicator software component 70 enables the system to script, send and display on the customer's television/set top box or computer display notices and messages such as notifications regarding service changes or regarding broadcast scheduling changes affecting programs which have been scheduled for recording, promotional features, telephone message caller ID and recorded messages.

The IPG may also provide access to VOD, NVOD, VDVR, Timeless TV and TV-on-demand, Internet programming and video and audio content. “VOD” is an umbrella term referring to technologies that enable individuals to select a video (e.g., movie) from a static array of pre-recorded multimedia choices provided from a central server for viewing on a television or computer screen. The on-line applications enable individuals to select program content stored in a dynamic array of recorded video broadcasts provided from a central server for viewing on a television or a computer screen. The multimedia selection could, similarly, provide for games-on-demand whereby NINTENDO™-type games may be made available for access by subscribers through the IPG. Alternatively, a Web user interface may be provided for selection of a game whereby subscribers are charged per game/time played.

The on-demand VDVR software server 100 provides the user access to video playback using interactive DVR controls for optimal control. It includes tools for storing, managing and delivering real-time, full-screen video and audio content. In addition to tools for recording, storing, managing and delivering full screen video and audio content, it utilizes the core components of the system manager, including, but not limited to, Customer Profile Management 68, Interactive Program Guide 65, Consumer Self-Service 71, Operational Services 88, Multilingual Support (not shown), and Channel Packaging 104.

A conditional access system (not shown) consists of both a source and destination software component and is responsible for the encryption, as desired, of data between the source and destination to protect against unauthorized use or copying.

A consumer services application 80 enables and controls connection services, self-ordering services and provisioning. An automatic service function of the consumer services application 80 eliminates the need for the service provider (e.g., Telco service trucks) to go to the consumer's location to add or remove new channel offerings. Instead, the subscriber is provided the means to change channel/package information online. Consumer profiles are updated immediately to the consumer's STB or PC by way of IP Multicast and/or SNMP. This eliminates any need for equipment and/or personnel's physical presence to be dispatched to the user's home to connect or disconnect the appropriate channels. An administration services application 82 handles, inter alia, the importation of IPG data on a scheduled basis. Channel packaging, which enables a user to manage the user's subscription (including self-service), is provided by a user interface module 71 and enables the user to view, add and delete channels from the user's service subscription. A report and billing software application 84 provides integrated billing and reporting which enables a user (subscriber) to dynamically monitor service usage, keep track of service costs on a self-serve basis and pay bills. A user is able to utilize this ability to monitor the household's viewing history to determine, for example, the amount of television being viewed by children and whether the programs watched are suitable. A database software component 86 provides an information database of broadcast content unique to the broadcast distribution system provider to feed the IPG database. An operational services component 88 of the system manager integrates the control of all the broadcast delivery system components into a networked management framework and provides quality management functions and collects usage information.

Additionally, the DTVM enables remote management of the user appliances including the ability to query and reset key indicators such as system health indicators (e.g., MPEG diagnosis), application and network status (e.g., current viewed channel, current NFS server), and to re-initialize a user device. This may be accomplished by, for example, an SNMP protocol. The DTVM also remotely informs the user, to the user's set top box or computer display, that new data and/or software is available and should be retrieved. This may be accomplished by, for example, IP multicast and/or SNMP.

The broadcast delivery system may also provide to the service provider an option of assigning URL's to channel numbers. A URL is an address used to enable an Internet browser program to find a particular Internet resource, for example, ‘http://www.imagictv.com’. Using this feature a subscriber could view a URL channel on the IPG similar to a television or video channel. Subscribers are then able to scan through URL channels and select a desired URL by entering the associated numbers from the remote device in the same way as television or video channels are selected. Going through a URL channel would switch the user device (e.g., the set top box or PC) to a web browser and thereby access a selected web page. The broadcast delivery system may also provide for channel hotlinks such that while watching a program, or when a program is highlighted on the IPG, the user can operate a remote entry device to activate a transfer to a dynamic web page. Such web page could display, for example, information on the program, on the channel, or on the subject matter currently being shown.

The DTVM software enables a subscriber to personalize channel selection, for example, create a list of favourite programs which the user can scan on the IPG and select from or have the television/set top box (or computer) automatically switch to at designated times. In addition, a one touch search feature may be provided to enable a user to specify certain searching criteria, such as program theme, by actor, by program/movie title, etc, and initiate one step searching to retrieve requested programming information from the IPG. Similarly, the user may be provided with the ability to view a program's video trailer from the interactive program guide when the user “clicks on”/selects that program. The DTVM software may also provide an intelligent agent which may be set up to remind a user of an upcoming program, or recommend program content based on user criteria, provide gathered data from outside source such as TV Guide, movie critics, etc.

Other features provided by the DTVM include Multicast download where information required to boot a network device to a multicast group is constantly delivered by a network server. The DHCP server is configured to return the multicast address and port as parameters in a BOOTP response. The network device is programmed to join the multicast group and download a bootstrap program to local memory and boot from the local memory rather than across the network. Also, the system can provide a multicast file system wherein a server constantly delivers a read-only file system to a multicast group. A network device is programmed to access the file system by joining the multicast group and waiting until the requested file appears. Encryption is used for security and compression is used to minimize bandwidth. Since multicast UDP may lose packets, the multicast group is rejoined and holes in the files are filled if holes exist.

For the PC user, the DTVM includes a PC component for installation in the PC which, advantageously, allows the user to watch television programming on a PC using the normal PC hardware and without requiring special hardware such as a TV tuner card. The PC component utilizes the core components of the DTVM such as Report and Billing Services 84 (including Integrated Reporting, Integrated Billing, and Service Administration), Administrative Services 82 (including LPG Data Import, Channel Packaging and Service Administration), Consumer Services 80 (including Connect Services, Consumer Self-Service and Provisioning), the Interactive Program Guide Client (including NVOD, Live Mpeg, Notifiers and Indicators, Profile, IPG Data Delivery and a Banner Service), the Browser Client (including Email, the World Wide Web, VOD, the On-Demand products, and Self-Ordering) and the Operational Services 88 (including Event Export, Event Collection and Network Management). On the client side, the PC component provides all of its functionality in software.

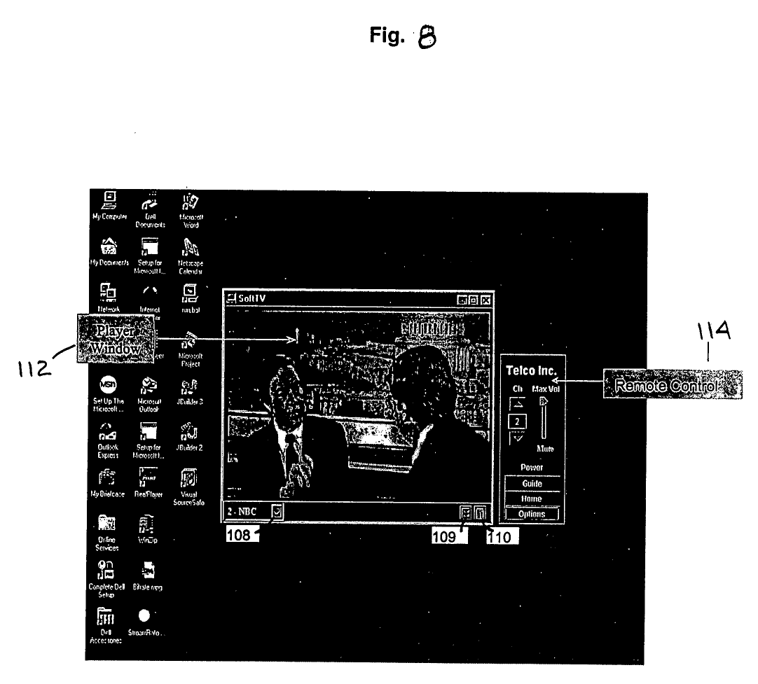

The PC component is itself comprised of three main components: a player window component, a virtual remote control component and an IPG component. The player window component provides a resizable viewing window 112, as illustrated by FIG. 8, containing three selectable objects: a channel selector 108, a program guide icon 109, and a remote control icon 110. The channel selector 108 is a pull down window that enables the user to select and retrieve an IP multicast stream corresponding to a specific channel. When the remote control icon 110 is selected a virtual remote controller 114 (being a window-type GUI) is opened and displayed as illustrated in FIG. 8. When the program guide icon is selected an IPG as shown by FIG. 7 appears as a separate contollable window.

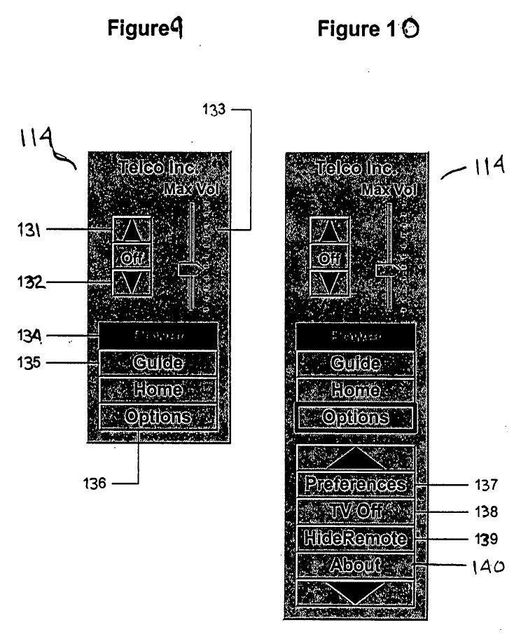

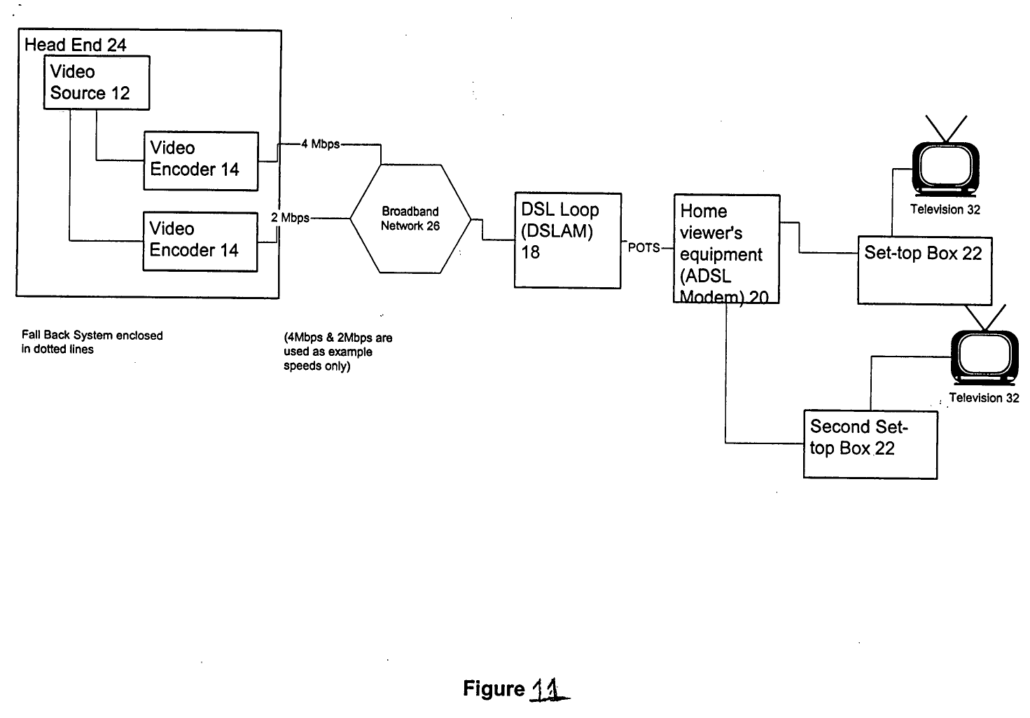

The PC component is navigated by the user using traditional windows-based click functions on drop down lists, together with the virtual remote control. The remote control design is such that, for user comfort, it represents a virtual model of the known physical hand-held remote controllers. The virtual remote controller 114, showing the basic functions available, is illustrated in FIG. 9. FIG. 10 shows the “options” box selected for the virtual controller 114 and the various optional functions which are available to the user are displayed below the “options” button. As shown by FIGS. 9 and 10 the virtual remote controller 114 includes user-selectable features for channel up 131, channel down 132, volume control 133, power off 134, Guide (i.e., go to IPG) 135 plus an expandable options feature 136 providing “preferences” 137 (viz. which directs the system manager to always hide the remote controller on start-up or to display the remote contoller to the left, to the right or always on top of the player window), TV Off 138 (which directs the system manager to turn off the player window but to continue to run the system manager), Hide Remote 139 (which directs the system manager to close the virtual remote controller display) and About 140 which provides particulars of the version of the system manager application which is being run. The DTVM's Interactive Program Guide is interactive and allows users to scroll up, down, forward or back through several days of programming. A further optional function which can be provided by the PC component is to enable the subscriber to store a received program in the hard drive of the PC whereby the PC would emulate a Personal Digital Recording device.

The PC component is made available to the user through downloading of software from a Web-based self-service component 71. The download software includes a Java Runtime Environment and Java Media Framework (being executables which are required by the PC component) and a PC setup program module. Once installed the PC component retrieves the IP address of the Application Server, the default language and the help desk registration number from the local config file downloaded during the install process. It then establishes a connection to the Application Server and retrieves the system data from a Registry file. It also retrieves the IP addresses and ports of the IPG data and IPG related data from the database. To retrieve IPG related data the PC periodically joins the IP Multicast group for the IPG related data for the specified IP address and port, waits for the beginning of the stream and downloads the IPG data until the end of the stream and then extracts and stores the program information for existing stations including schedule information on its local drive. The delivery system searches the server for the consumer file to confirm the consumer has subscribed to the service and retrieves the consumer specific information from the consumer file including any custom profiles the user may have created.

Channel selection for the PC component is identical to that for the STB in that when the user selects a channel from the channel lineup, the system checks for the source type of the channel and, ilf it's video/audio, it gets the IP multicast address and port of the selected channel from the IPG Related Data object and ‘tunes’ into the channel by joining the multicast address, thereby retrieving the signal from the transport network rather than, as in conventional tuning systems, tuning into one of several signals broadcast into the home. If the source is a Web channel, the system clears the player window, gets the homepage URL associated with the channel, and launches the default browser for the already retrieved URL. In the home, subscribers select a channel number on the virtual remote controller. This triggers the PC component to issue an IGMP (Internet Group Management Protocol) request to join the corresponding IP multicast address. That is, the channel entry triggers the PC component to ‘tune into’ the IP multicast address where the channel can be found. To service the request, an IGMP-enabled network router sends channel data to the PC. Completing the process, the PC decodes the packetized MPEG stream into video and audio for display on the PC monitor.

Optionally, as shown by FIG. 11, concurrent transmission of each channel via both MPEG-1 and MPEG-2 may be provided to allow fall back when access bandwidth becomes impaired. This, in effect, provides a backup system if failure occurs on the main transmission facility. Use of such a back-up system, based on a configurable algorithm, enables the system manager to recognize that there has been a failure to deliver a video signal and, on doing so, to switch to an alternate signal. This increases the level of broadcast availability in the event of a loop (e.g., XDSL) impairment, encoder failure, or facility/network failure. This also allows for multiple client devices (STBs and/or PCs) in a single home to negotiate for the best available signal.

The terms algorithm, module and component herein are used interchangeably and refer to any set of computer-readable instructions or commands such as in the form of software, without limitation to any specific location or means of operation of the same. The terms subscriber, consumer and customer are also used interchangeably herein to refer to PC/STB user of the broadcast delivery system.

It is to be understood that the specific elements of the events capturing system and method described herein are not intended to limit the invention defined by the appended claims. From the teachings provided herein the invention could be implemented and embodied in any number of alternative computer program embodiments by persons skilled in the art without departing from the claimed invention.

### Appendix A—Glossary

BootP Refers to Bootstrap Protocol which is an Internet protocol that enables a diskless workstation to discover its own IP address, the IP address of a BOOTP server on the network, and a file to be loaded into memory to boot the machine. This enables the workstation to boot without requiring a hard or floppy disk drive.

Daemon A process that runs in the background and performs a specified operation at predefined times or in response to certain events. The term daemon is a UNIX term, though many other operating systems provide support for daemons.

Data Provider For the subject matter herein described, a company that provides detailed information about television programs, including station information, show titles, scheduled air times, etc.

DHCP Dynamic Host Configuration Protocol. A protocol for assigning dynamic IP addresses to devices on a network. With dynamic addressing, a device can have a different IP address every time it connects to the network. In some systems, the device's IP address can even change while it is still connected. DHCP also supports a mix of static and dynamic IP addresses. Dynamic addressing simplifies network administration because the software keeps track of IP addresses rather than requiring an administrator to manage the task. This means that a new computer can be added to a network without the hassle of manually assigning it a unique IP address. Many ISPs use dynamic IP addressing for dial-up users.

Domain A group of computers and devices on a network that are administered as a unit with common rules and procedures. Within the Internet, domains are defined by the Internet Protocol (IP) address. All devices sharing a common part of the IP address are said to be in the same domain.

DNS Domain Name System. An Internet service that translates domain names into IP addresses. For example, a DNS server might translate the domain name “www.example.com” into the EP address 198.105.232.4.

DSLAM Digital Subscriber Line Access Multiplexer. A technology that concentrates traffic in xDSL implementations through a process of TDM (time division multiplexing) at the Telco's central office (CO) or remote line shelf.

HTTP Hypertext Transfer Protocol. The underlying protocol used by the World Wide Web. HTTP defines how messages are formatted and transmitted, and what actions Web servers and browsers should take in response to various commands. For example, when you enter a URL in your browser, this actually sends an HTTP command to the Web server directing it to fetch and transmit the requested Web page.

IGMP Internet Group Management Protocol. Defined in RFC 1112 as the Internet standard for IP multicasting. IGMP establishes host memberships in particular multicast groups on a single network. The mechanisms of the protocol allow a host to inform its local router, using Host Membership Reports, that it wants to receive messages addressed to a specific multicast group. All hosts conforming to level 2 of the IP multicasting specification require IGMP.

IP address An identifier for a computer or device on a TCP/IP network. Networks that use the TCP/IP protocol route messages based on the IP address of the destination. The format of an IP address is a 32-bit numeric address written as four numbers separated by periods. Each number can be zero to 255. For example, 1. 160.10.240 can be an IP address.

IP Multicast Sending out data to distributed servers on the MBone (Multicast Backbone). For large amounts of data, IP Multicast is more efficient than normal Internet transmissions because the server can broadcast a message to many recipients simultaneously. Unlike traditional Internet traffic that requires separate connections for each source—destination pair, IP Multicasting allows many recipients to share the same source. This means that just one set of packets is transmitted for all the destinations.

JDBC Java Database Connectivity. A Java API (Application Interface) that enables Java programs to execute SQL statements. This allows Java programs to interact with any SQL-compliant database. Since nearly all relational database management systems support SQL, and because Java itself runs on most platforms, JDBC makes it possible to write a single database application that can run on different platforms and interact with different database management systems.

Macrovision An anti-taping process that protects original material from video piracy. For example, a viewer cannot record a pay-per-view movie if Macrovision protection is in place.

MAC address Media Access Control address. A hardware address that uniquely identifies each node of a network. In IEEE 802 networks, the Data Link Control (DLC) layer of the OSI Reference Model is divided into two sublayers: the Logical Link Control (LLC) layer and the Media Access Control (MAC) layer. The MAC layer interfaces directly with the network media. Consequently, each different type of network media requires a different MAC layer.

MIB Management Information Base. A database of objects that a network management system can monitor. SNMP uses a standardized MIB format that allows any SNMP tool to monitor any device defined by a MIB.

MPEG Moving Picture Experts Group. A family of digital video compression standards and file formats. MPEG generally produces better-quality video than competing formats, such as Video for Windows, Indeo and QuickTime. MPEG files can be decoded by special hardware or by software. MPEG achieves a high compression rate by storing only the changes from one frame to another, instead of each entire frame. The video information is then encoded using a technique called DCT. MPEG uses a type of lossy compression, since some data is removed but the diminishment of data is generally imperceptible to the human eye. There are two major MPEG standards: MPEG-I and MPEG-2. Common implementations of the MPEG-I standard provide a video resolution of 352-by-240 at 30 frames per second (fps). This produces video quality slightly below the quality of conventional VCR videos. A newer standard, MPEG-2, offers resolutions of 720×480 and 1280×720 at 60 fps, with full CD-quality audio. This is sufficient for all the major TV standards, including NTSC, and even HDTV. MPEG-2 is used by DVD-ROMs. MPEG-2 can compress a two hour video into a few gigabytes. Suggested reading: MPEG Video Compression Standard, ISBN 0-412-08771-5; and, Digital Video: An Introduction To MPEG-2, ISBN 0-412-08411-2.

NAT Network Address Translation. An Internet standard that enables a local-area network (LAN) to use one set of IP addresses for internal traffic and a second set of addresses for external traffic. A NAT box located where the LAN meets the Internet makes all necessary IP address translations. NATs serve two main purposes: They provide a type of firewall by hiding internal IP addresses and they enable a company to use more internal IP addresses. Since they're only used internally, there's no possibility of conflict with IP addresses used by other companies and organizations.

NFS Network File System. An open architecture operating system designed by Sun Microsystems that allows all network users to access shared files stored on computers of different types. NFS provides access to shared files through an interface called the Virtual File System (VFS) that runs on top of TCP/IP. Users can manipulate shared files as if they were stored locally on the user's own hard disk. With NFS, computers connected to a network operate as clients while accessing remote files, and as servers while providing remote users access to local shared files. The NFS standards are publicly available and widely used. Because the set-top box referenced herein has no internal hard drive, it remotely accesses an NFS server to load its operating system, software, and preferences.

PDU Protocol Data Unit. An OSI (Open Systems Interconnection) term that means “packet”. A PDU is a data object exchanged by protocol machines (entities) within a given layer. PDUs consist of both data and control (protocol) information that allows the two to coordinate their interactions.

RFC Request for Comment. A series of notes about the TCP/IP standards, procedures, and specifications. Anyone can submit an RFC. Eventually, if it gains enough interest, it may evolve into an Internet standard. Each RFC is designated by an RFC number.

RMI Remote Method Invocation. A set of protocols being developed by Sun's JavaSoft division that enables Java objects to communicate remotely with other Java objects.

RPC Remote procedure call. A type of protocol that allows a program on one computer to execute a program on a server computer. Using RPC, a system developer need not develop specific procedures for the server. The client program sends a message to the server with appropriate arguments and the server returns a message containing the results of the program executed.

Servlet An applet that runs on a server. The term usually refers to a Java applet that runs within a web server environment. This is analogous to a Java applet that runs within a Web browser environment. Java servlets are becoming increasingly popular as an alternative to CGI programs. The biggest difference between the two is that a Java applet is persistent. This means that once it is started, it stays in memory and can fulfill multiple requests. In contrast, a CGI program disappears once it has fulfilled a request. The persistence of Java applets makes them faster because there's no wasted time in setting up and tearing down the process.

SNMP Simple Network Management Protocol. A set of protocols for managing complex networks. SNMP works by sending messages, called protocol data units (PDUs), to different parts of a network. SNMP-compliant devices, called agents, store data about themselves in Management Information Bases (MIBs) and return this data to the SNMP requesters.

Time Division Multiplexing A technique for transmitting a number of separate data, voice and/or video signals simultaneously over one communications medium by quickly interleaving a piece of each signal one after another.

TCP/IP Transmission Control Protocol/Internet Protocol. The suite of communications protocols used to connect hosts on the Internet. TCP/IP uses several protocols, the two main ones being TCP and IP. TCP/IP is built into the UNIX operating system and is used by the Internet, making it the defacto standard for transmitting data over networks.

UDP User Datagram Protocol. A connectionless protocol that, like TCP, runs on top of IP networks. Unlike TCP/IP UDP/IP provides very few error recovery services, offering instead a direct way to send and receive datagrams over an IP network. It's used primarily for broadcasting messages over a network. The system manager described herein uses the UDP protocol for the RPC server and this was chosen instead of TCP because TCP allows a limited number of set-top box connections through the RPC server. If the RPC server went down, the set-top boxes could not reconnect.

URL Universal Resource Locator. An address format used by a Web browser for locating an lnternet resource.

xDSL x Digital Subscriber Line. Generic term for all types of digital subscriber lines, including ADSL (Asymmetrical DSL) and VDSL (Very-high-data-rate DSL). DSL technologies use complex modulation schemes to pack data onto copper wires. They are sometimes referred to as last-mile technologies because they are used only for connections from a telephone switching station to a home or office, not between switching stations. xDSL is similar to ISDN inasmuch as both operate over existing copper telephone lines (POTS) and both require short runs to a central telephone office, usually less than 20,000 feet. However, xDSL offers much higher speeds—up to 32 Mbps for downstream traffic, and from 32 Kbps to over I Mbps for upstream traffic.

1-24. (Cancelled)

25. A digital interactive delivery system for managing interactive access of a subscriber device to a plurality of video sources transmitted over a broadband communication network, comprising:
a user interface for: (i) associating a plurality of video content items provided by said plurality of video sources with said subscriber device; and (ii) enabling selection of a specified one of said plurality of video content items for viewing on said subscriber device;
an access element for: (i) establishing a connection between said subscriber device and respective video source locations associated with each of said plurality of video content items; (ii) transmitting said specified one of said plurality of video content items to said subscriber device; and (iii) establishing a connection between said subscriber device and a digital television management (DTVM) component for profile management, account administration and interactive program guide (IPG) access,
wherein said access element is an Asymmetrical Digital Subscriber Line (ADSL) modem, and wherein said ADSL modem communicates with a Digital Subscriber Line Access Multiplexer (DSLAM).

26. The digital interactive delivery system of claim 25, wherein said user interface comprises:
an IPG component configured according to a subscriber profile associated with said subscriber device, said IPG component for communicating with said interactive program guide associated with said DTVM component, said interactive programming guide comprising a list of each of said plurality of video content items, and respective video source locations associated with each of said plurality of video content items; and
a subscriber input interface for enabling identification of said specified one of said plurality of video content items.

27. The digital interactive delivery system of claim 26 wherein said subscriber device comprises a set top box and a television coupled thereto, said set top box comprising a decoder configured for converting a specified one of said plurality of video sources into a display format for display on said television, and wherein said specified one of said plurality of video sources is in MPEG-1 or MPEG-2 format.

28. The digital interactive delivery system of claim 27 wherein said set top box further comprises subscriber device components including a Moving Picture Experts Group (MPEG) player, a browser, a networking application programming interface (API) and a windowing API.

29. The digital interactive delivery system of claim 26 wherein ADSL lines connect said DSLAM to a first ethernet interface on said ADSL modem and a 10BaseT cable connects said first ethernet interface to a second ethernet interface on said set top box.

30. The digital interactive delivery system of claim 29 wherein said subscriber input interface comprises a remote device.

31. The digital interactive delivery system of claim 30 wherein said list associated with said IPG further includes an information block associated with each of said plurality of video content items.

32. The digital interactive delivery system of claim 31 wherein said list associated with said EPG comprises program schedule cells and associated channel lineup cells.

33. The digital interactive delivery system of claim 25 wherein said subscriber device comprises a computer and a computer monitor coupled thereto, said computer comprising a decoder configured for converting a specified one of said plurality of video sources into a display format for display on said monitor, and wherein said specified one of said plurality of video sources is in MPEG-1 or MPEG-2 format.

34. The digital interactive delivery system of claim 33 wherein said subscriber device further comprises a PC component and wherein said PC component comprises an IPG component, a player window component and a virtual remote control component, and wherein said player window component comprises a channel selector icon, a program guide icon and a remote control icon, and wherein when said remote control icon is engaged by said subscriber, a virtual remote controller is displayed.

35. The digital interactive delivery system of claim 34 wherein said virtual remote controller is controllable by said subscriber through a subscriber input device comprising a keyboard and a mouse.

36. The digital interactive delivery system of claim 34 wherein said IPG component is configured according to a subscriber profile associated with said subscriber device, and wherein said IPG component communicates with said interactive program guide associated with said DTVM component, and wherein said interactive programming guide comprises a list of each of said plurality of video content items, and respective video source locations associated with each of said plurality of video content items.
